(19) United States
(12) Patent Application Publication
(10) Pub. No.: US 2025/0202556 A1
(43) Pub. Date: Jun. 19, 2025

(54) INFORMATION PROCESSING METHOD AND APPARATUS, COMMUNICATION DEVICE, AND STORAGE MEDIUM

(71) Applicant: Beijing Xiaomi Mobile Software Co., Ltd., Beijing (CN)

(72) Inventors: Qin MU, Beijing (CN); Xuemei QIAO, Beijing (CN); Yifan CAI, Beijing (CN)

(73) Assignee: Beijing Xiaomi Mobile Software Co., Ltd., Beijing (CN)

(21) Appl. No.: 18/846,516

(22) PCT Filed: Mar. 14, 2022
(86) PCT No.: PCT/CN2022/080785

§ 371 Date: Sep. 12, 2024

(51) Int. Cl. H04B 7/06; H04L 41/16; H04W 8/22

(52) U.S. Cl. CPC H04B 7/0626; H04B 7/0658; H04L 41/16; H04W 8/22

(57) ABSTRACT

An information processing method, performed by a base station, and includes: determining whether a terminal supports compression of channel state information-reference signal (CSI-RS) feedback information with at least one artificial intelligence (AI) model; and configuring a CSI-RS according to whether the terminal supports compression of the CSI-RS feedback information with the at least one AI model.

### CROSS-REFERENCE TO RELATED APPLICATION

The present application is a U.S. National Phase of International Patent Application Serial No. PCT/CN2022/080785 filed on Mar. 14, 2022. The contents of this application are hereby incorporated by reference in their entirety for all purposes.

### BACKGROUND OF THE INVENTION

Channel state information provides a description of a current channel environment. In a mobile communication network, a base station transmits a channel state information-reference signal (CSI-RS), and a terminal evaluates and quantizes channel state information and feeds it back to the base station. By introducing channel state information (CSI) feedback information, the base station side can make timely adjustments when transmitting the channel state information-reference signal, so a bit error rate can be reduced at the terminal, and an optimal reception signal can be obtained.

### SUMMARY OF THE INVENTION

Examples of the disclosure provide a method and apparatus for processing information, a communication device, and a storage medium.

In a first aspect, a method for processing information is provided in an example of the disclosure. The method is performed by a base station and includes: determining whether a terminal supports compression of channel state information-reference signal (CSI-RS) feedback information with at least one artificial intelligence (AI) model; and configuring a CSI-RS according to whether the terminal supports compression of the CSI-RS feedback information with the at least one AI model.

In a second aspect, a method for processing information is provided in an example of the disclosure. The method is performed by a terminal and includes: transmitting second information, where the second information is used for a base station to determine whether the terminal supports compression of CSI-RS feedback information with at least one AI model.

In a third aspect, a communication device is provided in an example of the disclosure. The communication device includes one or more processors, a transceiver, a memory, and an executable program stored in the memory and executable by the one or more processors, where the one or more processors executes the method for processing information in the first aspect or the second aspect when running the executable program.

In a fourth aspect, a non-transitory computer-readable storage medium is provided in an example of the disclosure. The non-transitory computer-readable storage medium stores an executable program, where the executable program implements the method for processing information in the first aspect or the second aspect after being executed by one or more processors.

It should be understood that the foregoing general description and the following detailed description are illustrative and explanatory merely and do not restrict the examples of the disclosure.

### BRIEF DESCRIPTION OF DRAWINGS

The drawings here are incorporated in the description as a constituent part of the description, illustrate examples conforming to the disclosure, and serve to explain principles of the disclosure along with the description.

FIG. 1 is a schematic structural diagram of a radio communication system according to an example.

FIG. 2 is a schematic flowchart of a method for processing information according to an example.

FIG. 3 is a schematic flowchart of a method for processing information according to an example.

FIG. 4 is a schematic flowchart of a method for processing information according to an example.

FIG. 5 is a schematic flowchart of a method for processing information according to an example.

FIG. 6 is a schematic flowchart of a method for processing information according to an example.

FIG. 7A is a schematic flowchart of a method for processing information according to an example.

FIG. 7B is a schematic flowchart of a method for processing information according to an example.

FIG. 8 is a schematic flowchart of a method for processing information according to an example.

FIG. 9 is a schematic flowchart of a method for processing information according to an example.

FIG. 10 is a schematic flowchart of a method for processing information according to an example.

FIG. 11 is a schematic flowchart of a method for processing information according to an example.

FIG. 12 is a schematic flowchart of a method for processing information according to an example.

FIG. 13 is a schematic flowchart of a method for processing information according to an example.

FIG. 14 is a schematic flowchart of a method for processing information according to an example.

FIG. 15 is a schematic structural diagram of an apparatus for processing information according to an example.

FIG. 16 is a schematic structural diagram of an apparatus for processing information according to an example.

FIG. 17 is a schematic structural diagram of a terminal according to an example.

FIG. 18 is a schematic structural diagram of a communication device according to an example.

### DETAILED DESCRIPTION OF THE INVENTION

Description will be made in detail to examples here, instances of which are illustrated in the accompanying drawings. When the following description relates to the accompanying drawings, the same numbers in different accompanying drawings denote the same or similar elements, unless indicated otherwise. The embodiments described in the following examples do not represent all embodiments consistent with the examples of the disclosure. Rather, they are merely instances of apparatus and methods consistent with some aspects of the examples of the disclosure.

The terms used in the examples of the disclosure are merely used to describe specific examples, rather than limit the examples of the disclosure. As used in the disclosure, singular forms “a”, “an” and “the” are intended to include plural forms as well, unless otherwise indicated in the context clearly. It should also be understood that the term “and/or” as used here refers to and encompasses any or all possible combinations of one or more of associated items listed.

It should be understood that although the terms of first, second, third, etc. may be used in the examples of the disclosure to describe various information, such information should not be limited to these terms. These terms are merely used to distinguish the same type of information from each other. For example, first information may also be referred to as second information, and similarly, second information may also be referred to as first information, without departing from the scope of the examples of the disclosure. The word “if” as used here may be construed to mean “at the time of” or “when” or “in response to determining”, depending on the context.

The disclosure relates to, but is not limited to, the technical field of radio communication, and in particular relates to a method and apparatus for processing information, a communication device, and a storage medium.

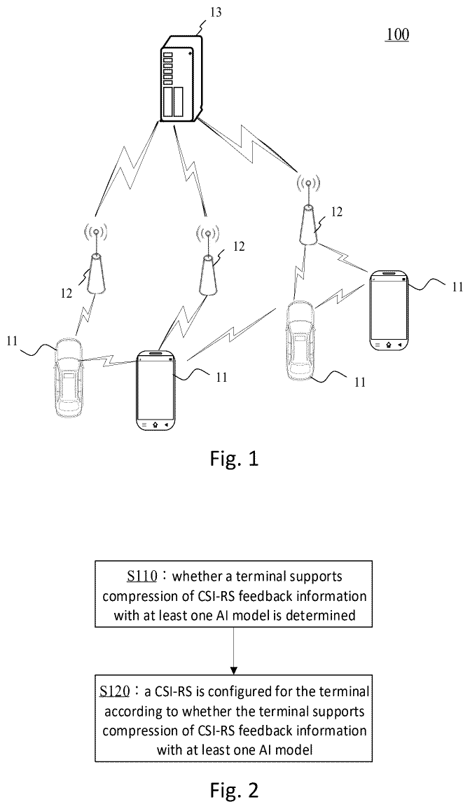

With reference to FIG. 1, a schematic structural diagram of a radio communication system 100 according to an example of the disclosure is shown. As shown in FIG. 1, the radio communication system 100 is a communication system based on cellular mobile communication technology and may include: one or several terminals 11 and one or several access devices 12.

Each terminal 11 may be a device that provides speech and/or data connectivity for a user. The terminal 11 may communicate with one or more core networks by means of a radio access network (RAN), and the terminal 11 may be an Internet of Things terminal, for example, a sensor device, a mobile telephone (or referred to as a “cellular” telephone), and a computer having an Internet of Things terminal, for example, may be a stationary, portable, pocket-sized, hand-held, computer-built, or vehicle-mounted device, for example, a station (STA), a subscriber unit, a subscriber station, a mobile station, a mobile, a remote station, an access point, a remote terminal, an access terminal, a user terminal, a user agent, a user device, or user equipment (UE). Alternatively, the terminal 11 may be a device of an unmanned aerial vehicle. Alternatively, the terminal 11 may be an in-vehicle device, for example, a trip computer with a radio communication function, or a radio communication device to which a trip computer is externally connected. Alternatively, the terminal 11 may be a roadside device, for example, a street lamp, a signal lamp, another roadside device, etc. with the radio communication function.

The access device 12 may be a network side device in the radio communication system. The radio communication system may be a 4th generation mobile communication (4G) system, which is also referred to as a long term evolution (LTE) system. Alternatively, the radio communication system may also be a 5th generation mobile communication (5G) system, which is also referred to as a new radio (NR) system or a 5G NR system. Alternatively, the radio communication system may also be a next generation system following the 5G system. An access network in the 5G system may be referred to as a new generation-radio access network (NG-RAN), or a machine-type communication (MTC) system.

The access device 12 may be an evolved node B (eNB) used in the 4G system. Alternatively, the access device 12 may also be a next generation node B (gNB) using a central-distributed architecture in the 5G system. When using the central-distributed architecture, the access device 12 typically includes a central unit (CU) and at least two distributed units (DUs). The central unit is provided with a protocol stack of a packet data convergence protocol (PDCP) layer, a radio link control (RLC) layer, and a media access control (MAC) layer. Each distributed unit is provided with a protocol stack of a physical (PHY) layer. Particular embodiments of the access device 12 are not limited in the examples of the disclosure.

The access devices 12 are in radio connection to the terminals 11 through wireless radios. In different embodiments, the wireless radio is a wireless radio based on a standard of the 4th generation mobile communication (4G) or a standard of the 5th generation mobile communication (5G), and is a new radio, for example. Alternatively, the wireless radio may also be a wireless radio based on a standard of next generation mobile communication following 5G.

In some embodiments, the wireless communication system 100 may further include a network management device 13.

As shown in FIG. 2, a method for processing information is provided in an example of the disclosure. The method is performed by a network side device and includes steps S110 and S120.

S110: whether a terminal supports compression of CSI-RS feedback information with at least one AI model is determined.

S120: a CSI-RS is configured for the terminal according to whether the terminal supports compression of CSI-RS feedback information with at least one AI model.

In the example of the disclosure, the network side device may be a base station. The base station may be an evolved base station (eNB) and/or a next generation base station (gNB), or a base station of any generation communication system. Certainly, the network side device is not limited to the base station, but may also be any device in a network, which is not limited here.

The base station transmits the CSI-RS, the terminal receives the CSI-RS, and the terminal generates CSI-RS feedback information according to its own CSI-RS reception status. For example, the CSI-RS feedback information may be used for the network side device to determine the CSI-RS reception status of the terminal, for example, whether the CSI-RS on a corresponding transmission resource block is received and/or reception power of the terminal to the CSI-RS.

In some examples, a data size of the CSI-RS feedback information may be relatively large. In some cases, the terminal may only transmit part of the CSI-RS feedback information to the network side device. In some cases, the terminal may process the CSI-RS feedback information by using an AI model. CSI-RS feedback information reported by the terminal is processed CSI-RS feedback information. The processed CSI-RS feedback information may be processed by the network side device (for example, a base station), and then complete CSI-RS feedback information of the terminal is obtained.

In an implementation, processing of the CSI-RS feedback information by using the AI model may be that the terminal compresses the CSI-RS feedback information by using the AI model. In view of this, the terminal reports compressed CSI-RS feedback information. Complete CSI-RS feedback information of the terminal can be obtained after the compressed CSI-RS feedback information is decompressed correspondingly by the base station.

However, using the AI model to process the CSI-RS feedback information generally requires at least the terminal to have an AI operation capability. For example, when the terminal includes an AI chip, the terminal has the AI operation capability. Different AI chips have different AI computation capabilities. Different AI models have different computation capability requirements. Thus, some terminals may support processing of the CSI-RS feedback information through all AI models, some terminals may only support processing of the CSI-RS feedback information through some AI models, and some terminals do not support processing of the CSI-RS feedback information through AI models at all.

In the following examples, the AI model is used to compress the CSI-RS feedback information, but those skilled in the art can understand that the processing of the CSI-RS feedback information by using the AI model may also include other operations, which are not repeated here.

In the example of the disclosure, the network side device such as the base station first determines whether the terminal supports the at least one AI model in processing the CSI-RS feedback information. According to a determination result, the CSI-RS configuration for the UE is generated. In this way, it can be guaranteed that the generated CSI-RS configuration is adapted to whether the UE supports the AI model in compressing the CSI-RS feedback information, and UE measurement anomaly caused by the non-adapted CSI-RS configuration is reduced.

The generated CSI-RS configuration may be transmitted to the terminal through a radio resource control (RRC) message or a medium access control element (MAC CE).

A method for processing information is provided in an example of the disclosure. The method is performed by a network side device and includes a CSI-RS used by the terminal is determined in response to determining that the terminal supports the AI model in processing the CSI-RS feedback information, where the CSI-RS corresponds to the AI model supported by the terminal.

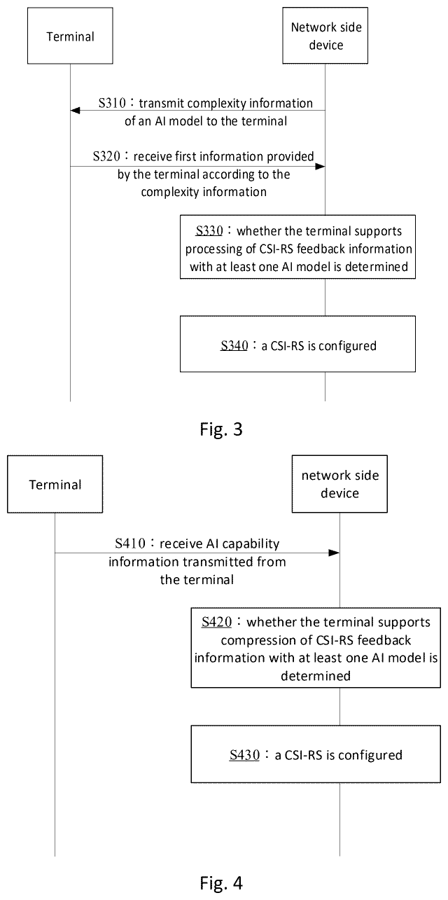

As shown in FIG. 3, a method for processing information is provided in an example of the disclosure. The method is performed by a network side device and includes steps S310 through S340.

S310: complexity information of the AI model is transmitted to the terminal.

S320: first information provided by the terminal according to the complexity information is received.

S330: whether the terminal supports processing of CSI-RS feedback information with at least one AI model is determined according to the first information.

S340: a CSI-RS is configured according to whether the terminal supports processing of CSI-RS feedback information with at least one AI model.

In an implementation, processing of the CSI-RS feedback information by using the AI model may be that the terminal compresses the CSI-RS feedback information by using the AI model. In view of this, the terminal reports compressed CSI-RS feedback information. Complete CSI-RS feedback information of the terminal can be obtained after the compressed CSI-RS feedback information is decompressed correspondingly by the network side device (for example, the base station). In the following examples, the AI model is used to compress the CSI-RS feedback information, but those skilled in the art can understand that the processing of the CSI-RS feedback information by using the AI model may also include other operations, which are not repeated here.

In the example of the disclosure, the network side device transmits the complexity information of the AI model to the terminal. After the complexity information is transmitted to the terminal, the terminal may determine whether to support the corresponding AI model in compressing the CSI-RS feedback information based on its own AI capability. Certainly, the network side device and the terminal may also perform determination by candidate AI models determined by a communication protocol, which is not repeated here.

The complexity information may be transmitted from the base station to the terminal through an RRC message or an MAC CE.

The first information may be various information used for the network side device (such as a base station) to determine whether the terminal supports the AI model in compressing the CSI-RS feedback information. Alternatively, the first information may indicate that the terminal determines which AI model to compress the CSI-RS feedback information.

In this way, the terminal actually determines whether to support the AI model in compressing the CSI-RS feedback information and informs the base station.

In some examples, the first information may explicitly indicate whether the terminal supports the AI model in compressing the CSI-RS feedback information or that the terminal supports which AI model in compressing the CSI-RS feedback information.

In some other examples, the first information may further implicitly indicate whether the terminal supports the AI model in compressing the CSI-RS feedback information and/or supports which AI model in compressing the CSI-RS feedback information.

In some examples, the first information indicating that the terminal supports compression of the CSI-RS feedback information with the at least one AI model includes at least one of parameters: a model identifier indicating the AI model supported by the terminal for compressing the CSI-RS feedback information; and CSI computation duration indicating duration required by using the AI model with the model identifier to compress the CSI-RS feedback information by the terminal.

Certainly, the CSI computation duration may be the duration itself or a parameter used to determine the CSI computation duration. For example, the CSI computation duration may be a computation capability of the AI model or a computation capability of the terminal. In the example of the disclosure, the model identifier refers to an AI model supported by the terminal.

In some other examples, the model identifier may further indicate an AI model that is not supported by the terminal.

The CSI computation duration may be a duration required for the terminal to compress the CSI-RS feedback information by using the corresponding AI model. If the CSI computation duration is greater than a maximum duration allowed by the base station, even if the terminal supports the AI model, the network side device may not configure the terminal to use the AI model to compress the CSI-RS feedback information due to timeout.

In the example of the disclosure, the first information is equivalent to information implicitly indicating whether the terminal supports the AI model in compressing the CSI-RS feedback information. If the first information does not carry any model identifier or the terminal does not transmit the first information, it is equivalent to indicating that the terminal does not support any AI model in compressing the CSI-RS feedback information. If the first information carries at least one model identifier, it indicates that the terminal supports at least one AI model in compressing the CSI-RS feedback information.

In some examples, the first information indicating that the terminal does not support compression of CSI-RS feedback information with at least one AI model indicates that a partial reporting mode is used for the CSI-RS feedback information.

If the first information indicates that the terminal transmits the CSI-RS feedback information to the base station in a manner of partially reporting the CSI-RS feedback information, it is equivalent to implicitly indicating that the terminal does not support the AI model in compressing the CSI-RS feedback information or that the terminal does not expect to use the AI model to compress the CSI-RS feedback information.

In some other examples, the first information may include a bit specifically indicating whether the terminal supports the AI model in compressing the CSI-RS feedback information.

In some other examples, the first information may include a bitmap. The bitmap may include N bits, where N≥1, and each bit corresponds to one AI model. One bit in the bitmap is used to indicate whether the terminal supports a corresponding AI model in compressing the CSI-RS feedback information.

In still some examples, the first information may include a bitmap. Bits of the bitmap may correspond to 2^{N} values, and each value corresponds to one AI model.

In some examples, the complexity information indicates at least one of: total floating-point operations per second of a corresponding AI model, where the total floating-point operations per second and a maximum allowable value of CSI computation duration are jointly used for the terminal to determine whether to support the corresponding AI model in compressing the CSI-RS feedback information; and a first ratio of complexity of the corresponding AI model to complexity of a baseline AI model, where the first ratio is used for the terminal to determine whether to support the corresponding AI model in compressing the CSI-RS feedback information in combination with the AI capability of the terminal and the complexity of the baseline AI model.

The baseline AI model here may be any one of a plurality of AI models that compress the CSI-RS feedback information, for example, one AI model designated by the base station or the terminal. The complexity of the baseline AI model may be an AI model known to both the base station and the UE.

In some examples, the baseline AI model may be an AI model with lowest complexity or highest complexity in a plurality of AI models that support in compressing the CSI-RS feedback information. Thus, a range of values of the first ratio may be limited to a certain range, such that bit overhead for indicating the first ratio is reduced.

In some examples, the complexity information may directly indicate the total floating-point operations per second of the corresponding AI model. After receiving the complexity information, the terminal may determine whether to support to use the corresponding AI model to compress the CSI-RS feedback information according to the maximum allowable value of the CSI computation duration configured by the base station or the maximum allowable value stipulated in the protocol.

In some other examples, in order to reduce signaling overhead, the complexity information is denoted by the ratio of the complexity of the corresponding AI model to that of the baseline AI model. The terminal indicates the total floating-point operations per second of the baseline AI model in advance, such that after receiving the first ratio, the terminal may also determine whether to support the corresponding AI model in compressing the CSI-RS feedback information.

As shown in FIG. 4, a method for processing information is provided in an example of the disclosure. The method is performed by a network side device, etc. and includes steps S410 through S430.

S410: AI capability information transmitted from the terminal is received.

S420: whether the terminal supports compression of CSI-RS feedback information with at least one AI model is determined according to the AI capability information.

S430: a CSI-RS is configured according to whether the terminal supports compression of CSI-RS feedback information with at least one AI model.

In the example of the disclosure, what the network side device such as the base station receives is the AI capability information transmitted from the terminal. The network side device such as the base station determines whether the terminal supports the AI model in compressing the CSI-RS feedback information or that the terminal supports which AI model in compressing the CSI-RS feedback information in combination with the AI capability information of the terminal and the complexity information of each AI model.

In some examples, the AI capability information indicates at least one of: whether the terminal has the AI capability; and a performance parameter of the terminal.

The performance parameter of the terminal may include at least one of parameters: a maximum AI capability of the terminal; floating-point operations per unit time (for example, per second) supported by the terminal; a processing capability supported by the terminal; floating-point operations per second supported by the terminal within a maximum allowable value of CSI computation duration; and/or a second ratio indicating a ratio of the AI capability of the terminal to complexity of a baseline AI model. Certainly, the performance parameter can also be represented by other parameters, which are not repeated here.

In some examples, the AI capability information may at least indicate whether the terminal has the AI capability. If the terminal has no AI capability, the AI capability information of the terminal does not carry the floating-point operations per unit time (for example, per second) supported by the terminal, or the total floating-point operations per second that the terminal can perform within the maximum allowable value of the CSI computation duration.

In some examples, in order to reduce signaling bit overhead, the AI capability of the terminal may be indirectly indicated by the second ratio. The larger the second ratio is, the higher the AI capability of the terminal is. If the second ratio is 0, it can be considered that the terminal has no AI capability.

If the floating-point operations per second, indicated by the AI capability information, supported by the terminal within the maximum allowable value of the CSI computation duration are 0, it indicates that the terminal has no AI capability. If the floating-point operations per second supported in the maximum allowable value of the CSI computation duration reported by the terminal are lower than the total floating-point operations per second of any AI model, it also indicates that the terminal does not support any AI model in compressing the CSI-RS feedback information. If the floating-point operations per second supported in the maximum allowable value of the CSI computation duration reported by the terminal are greater than or equal to the total floating-point operations per second of at least one AI model, it indicates that the terminal supports at least one AI model in compressing the CSI-RS feedback information.

After receiving the AI capability information reported by the terminal, the base station determines whether the corresponding terminal supports the AI model in compressing the CSI-RS feedback information.

In some examples, the CSI-RS is configured according to whether the terminal supports compression of the CSI-RS feedback information with the at least one AI model as follows: a type of the CSI-RS feedback information reported by the terminal is configured according to whether the terminal supports compression of the CSI-RS feedback information with the at least one AI model; and when the terminal supports compression of the CSI-RS feedback information with the at least one AI model, CSI computation duration when an AI model supported by the terminal is used to compress the CSI-RS feedback information is determined, and a period of the CSI-RS is configured.

The types of the CSI-RS feedback information reported here may include at least the following two types: compression information of the CSI-RS feedback information compressed by the AI model is reported; and the CSI-RS feedback information generated by the terminal is reported.

Certainly, the types of the CSI-RS feedback information reported can also be other types, which are not listed and repeated here.

If the terminal supports the AI model in compressing the CSI-RS feedback information, and the CSI computation duration is less than the maximum allowable value, the network side device determines the CSI computation duration required for the terminal to use the corresponding AI model to compress the CSI-RS feedback information, and configures the period of the CSI-RS.

For example, the CSI computation duration is positively correlated with the period of the CSI-RS.

In some examples, the network side device may further determine measurement duration of the CSI-RS according to the CSI computation duration. The measurement duration may be duration for measuring the CSI-RS in one period of the CSI-RS.

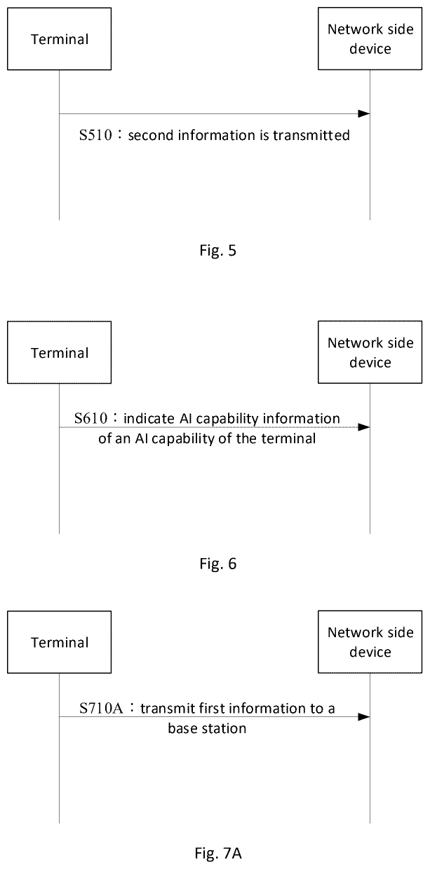

As shown in FIG. 5, a method for processing information is provided in an example of the disclosure. The method is performed by a terminal and includes S510.

S510: second information is transmitted, where the second information is used for a network side device to determine whether the terminal supports compression of CSI-RS feedback information with at least one AI model.

The example of the disclosure provides a method for processing information. The terminal transmits the second information to a base station. The second information may be used for a network side device to determine whether to use at least one AI model to compress the CSI-RS feedback information. In this way, the network side device can be informed of whether the terminal supports to use at least one AI model to compress the CSI-RS feedback information, and then it is convenient for the network side device to configure the CSI-RS according to whether the terminal supports to use the AI model to compress the CSI-RS feedback information or which AI model is used to compress the CSI-RS feedback information, such that the CSI-RS configuration generated by the base station is more consistent with the capability of the terminal.

As shown in FIG. 6, a method for processing information is provided in an example of the disclosure. The method is performed by a terminal and includes S610.

S610: AI capability information indicating an AI capability of the terminal is transmitted to the network side device.

In some examples, the AI capability information may be one type of the second information, or may be independent of the second information.

By reporting the AI capability information of the AI capability of the terminal, the network side device determines whether the terminal supports to use the AI model to compress the CSI-RS feedback information, and then generates the CSI-RS configuration for the terminal.

Illustratively, the AI capability information indicates at least one of: whether the terminal has the AI capability; a performance parameter of the terminal.

The performance parameter of the terminal may include at least one of parameters: a maximum AI capability of the terminal; floating-point operations per unit time (for example, per second) supported by the terminal; a processing capability supported by the terminal; floating-point operations per second supported by the terminal within a maximum allowable value of CSI computation duration; and/or a second ratio indicating a ratio of the AI capability of the terminal to complexity of a baseline AI model. Certainly, the performance parameter can also be represented by other parameters, which are not repeated here.

In some examples, the AI capability information may at least indicate whether the terminal has the AI capability. If the terminal has no AI capability, the AI capability information of the terminal does not carry the floating-point operations per unit time (for example, per second) supported by the terminal, or the total floating-point operations per second that the terminal can perform within the maximum allowable value of the CSI computation duration.

If the floating-point operations per second, indicated by the AI capability information, supported by the terminal within the maximum allowable value of the CSI computation duration are 0, it indicates that the terminal has no AI capability. If the floating-point operations per second supported in the maximum allowable value of the CSI computation duration reported by the terminal are lower than the total floating-point operations per second of any AI model, it also indicates that the terminal does not support any AI model in compressing the CSI-RS feedback information. If the floating-point operations per second supported in the maximum allowable value of the CSI computation duration reported by the terminal are greater than or equal to the total floating-point operations per second of at least one AI model, it indicates that the terminal supports at least one AI model in compressing the CSI-RS feedback information.

In some examples, in order to reduce signaling bit overhead, the AI capability of the terminal may be indirectly indicated by the second ratio. The larger the second ratio is, the higher the AI capability of the terminal is. If the second ratio is 0, it can be considered that the terminal has no AI capability.

After receiving the AI capability information reported by the terminal, the base station determines whether the corresponding terminal supports the AI model in compressing the CSI-RS feedback information.

As shown in FIG. 7A, a method for processing information is provided in an example of the disclosure. The method is performed by a terminal and includes S710A.

S710A: first information is transmitted to a network side device, where the first information is used to indicate whether the terminal supports compression of CSI-RS feedback information with at least one AI model.

The first information may be one type of the second information.

The first information may be generated after the terminal determines whether to support any AI model in compressing the CSI-RS feedback information according to the AI capability and complexity of each AI model.

The first information may be various information used for the network side device (such as a base station) to determine whether the terminal supports the AI model in compressing the CSI-RS feedback information, or may indicate that the terminal determines which AI model to compress the CSI-RS feedback information.

In some examples, the first information may explicitly or implicitly indicate whether the terminal supports the AI model in compressing the CSI-RS feedback information or that the terminal supports which AI model in compressing the CSI-RS feedback information.

In some examples, the first information indicating that the terminal supports compression of the CSI-RS feedback information with the at least one AI model includes: a model identifier indicating the AI model supported by the terminal for compressing the CSI-RS feedback information; and CSI computation duration indicating duration required by using the AI model with the model identifier to compress the CSI-RS feedback information by the terminal.

Certainly, the CSI computation duration may be the duration itself or a parameter used to determine the CSI computation duration. For example, the CSI computation duration may be a computation capability of the AI model or a computation capability of the terminal, etc.

In the example of the disclosure, the model identifier refers to an AI model supported by the terminal.

In some other examples, the model identifier may further indicate an AI model that is not supported by the terminal.

The CSI computation duration is a duration required for the terminal to compress the CSI-RS feedback information by using the corresponding AI model. If the CSI computation duration is greater than a maximum duration allowed by the base station, even if the terminal supports the AI model, the base station may not configure the terminal to use the AI model to compress the CSI-RS feedback information due to timeout.

In the example of the disclosure, the first information is equivalent to information implicitly indicating whether the terminal supports the AI model in compressing the CSI-RS feedback information. If the first information does not carry any model identifier or the terminal does not transmit the first information, it is equivalent to indicating that the terminal does not support any AI model in compressing the CSI-RS feedback information. If the first information carries at least one model identifier, it indicates that the terminal supports at least one AI model in compressing the CSI-RS feedback information.

In some examples, the first information indicating no support of the terminal indicates that a partial reporting mode is used for the CSI-RS feedback information.

If the first information indicates that the terminal transmits the CSI-RS feedback information to the base station in a manner of partially reporting the CSI-RS feedback information, it is equivalent to implicitly indicating that the terminal does not support the AI model in compressing the CSI-RS feedback information or that the terminal does not expect to use the AI model to compress the CSI-RS feedback information.

In some other examples, the first information may include a bit specifically indicating whether the terminal supports the AI model in compressing the CSI-RS feedback information. In some other examples, the first information may include a bitmap. The bitmap may include N bits, where N≥1, and each bit corresponds to one AI model. One bit in the bitmap is used to indicate whether the terminal supports a corresponding AI model in compressing the CSI-RS feedback information. Alternatively, the first information may include a bitmap. Bits of the bitmap may correspond to 2^{N} values, and each value corresponds to one AI model.

In some examples, as shown in FIG. 7B, the method further includes S710B and S720B.

S710B: complexity information of the AI model is received.

S720B: the first information is transmitted to the base station according to the complexity information of the AI model and an AI capability of the terminal.

In the example of the disclosure, the first information is determined according to the complexity information of the AI model received from the network side and the AI capability of the terminal.

In some other examples, the complexity information of the AI model may be determined by the terminal according to a protocol agreement or in other ways.

In short, in the example of the disclosure, the first information is not directly AI capability information of the AI capability of the terminal, but generated according to the complexity information of the AI model and the AI capability of the terminal and transmitted to the base station.

In some examples, the transmitting the first information to the base station according to the complexity information of the AI model and an AI capability of the terminal includes at least one of: the first information indicating that the at least one AI model is supported in compressing the CSI-RS feedback information is transmitted to the base station when it is determined that the terminal supports one AI model in compressing the CSI-RS feedback information according to the complexity information of the AI model and the AI capability of the terminal; the one AI model supported by the terminal is selected according to a resource scheduling situation of the terminal to indicate to the base station the first information of supporting the one AI model in compressing the CSI-RS feedback information when it is determined that the terminal supports a plurality of AI models in compressing the CSI-RS feedback information according to the complexity information of the AI model and the AI capability of the terminal; and the first information indicating that the terminal does not support compression of the CSI-RS feedback information with the at least one AI model is transmitted to the base station when it is determined that the terminal does not support the AI model in compressing the CSI-RS feedback information according to the complexity information of the AI model and the AI capability of the terminal.

In some cases, the terminal transmits the first information indicating that the base station supports at least one AI model in compressing the CSI-RS feedback information to the base station according to the complexity information of the AI model and an AI capability of the terminal without paying attention to which AI model the terminal specifically supports in compressing the CSI-RS feedback information. In this case, the first information may not include the model identifier of the AI model supported by the terminal, but the base station may consider that the terminal at least supports the baseline AI model. Thus, when configuring the CIS-RS for the terminal, the CIS-RS may be configured at least according to the complexity of the baseline AI model or the required CSI computation duration.

If the terminal not only determines whether the terminal supports compression of the CSI-RS feedback information with the at least one AI model according to the complexity information of each AI model and the AI capability, but also determines to support which AI model in compressing the CSI-RS feedback information, carries the model identifier of the AI model or reference information of the AI model that the terminal supports in compressing the CSI-RS feedback information in the first information, and transmits the first information to the terminal, the base station is informed that the terminal supports compression of the CSI-RS feedback information with the at least one AI model and that which AI model is supported in compressing the CSI-RS feedback information.

If the terminal has no AI capability or does not support any one AI model in compressing the CSI-RS feedback information indicated by the base station, the terminal transmits the first information indicating that the terminal does not support at least one AI model for the CSI-RS feedback information to the base station. Illustratively, the first information indicating that the terminal supports compression of the CSI-RS feedback information with the at least one AI model includes: a model identifier indicating the AI model supported by the terminal for compressing the CSI-RS feedback information; and CSI computation duration indicating duration required by using the AI model with the model identifier to compress the CSI-RS feedback information by the terminal.

Further illustratively, the first information indicating that the terminal does not support compression of CSI-RS feedback information with at least one AI model indicates that a partial reporting mode is used for the CSI-RS feedback information.

In some examples, the complexity information indicates at least one of: total floating-point operations per second of a corresponding AI model, where the total floating-point operations per second and a maximum allowable value of CSI computation duration are jointly used for the terminal to determine whether to support the corresponding AI model in compressing the CSI-RS feedback information; and a first ratio of complexity of the corresponding AI model to complexity of a baseline AI model, where the first ratio is used for the terminal to determine whether to support the corresponding AI model in compressing the CSI-RS feedback information in combination with the AI capability of the terminal and the complexity of the baseline AI model.

For example, the total floating-point operations per second of each AI model and the floating-point operations executed per unit time (for example, per second) that can be supported by the terminal can obtain actual computation duration required for the terminal to use the corresponding AI model to compress the CSI-RS feedback information. If the actual computation duration is less than the CSI computation duration and less than or greater than the maximum allowable value, it can be determined whether the terminal supports the corresponding AI model in compressing the CSI-RS feedback information.

If the complexity information is the first ratio, after receiving the first ratio, the terminal firstly obtains a third ratio of the floating-point operations per second that can be performed by the terminal at the maximum allowable value of the CSI computation duration to the floating-point operations per second required by the baseline AI model, and then compares the third ratio with the first ratio. If the third ratio is greater than or equal to the first ratio, it can be considered that the terminal supports the corresponding AI model in compressing the CSI-RS feedback information. If the third ratio is less than the first ratio, it can be considered that the terminal does not support the corresponding AI model in compressing the CSI-RS feedback information.

In the example of the disclosure, if the terminal does not support the AI chip or has no AI capability, after receiving the complexity information of the AI model transmitted from the base station, the terminal may directly report the first information indicating that the AI model is not supported in compressing the CSI-RS feedback information.

The example of the disclosure provides a method for defining the CSI computation duration of compressing AI-based CSI-RS feedback information, aiming at solving the problem of how to estimate the CSI computation duration at the terminal side when an AI model is introduced to compress the CSI-RS feedback information. When the AI model is introduced to compress the CSI-RS feedback information, main factors influencing the CSI computation duration include an AI processing capability of terminal hardware and the complexity of the AI model used.

The method provided in the example of the disclosure comprehensively considers the influences of the two aspects, and estimates the CSI computation duration after introducing the AI model, so as to provide strong support for determining whether the computation power of the terminal is sufficient to support using the AI model. Moreover, the base station side can configure the CSI-RS according to the estimated CSI computation duration.

The CSI computation duration may include duration required for compressing the CSI-RS feedback information by using the AI model.

Certainly, the CSI computation duration may be the duration itself or a parameter used to determine the CSI computation duration. For example, the CSI computation duration may be a computation capability of the AI model or a computation capability of the terminal.

The example of the disclosure provides a method for defining the CSI computation duration of compressing AI-based CSI-RS feedback information. The method includes the following. The network side device (in the below shown as the base station, for example) has complexity information of an available AI model. The terminal side has hardware computation capability information of the terminal. The base station may decide to estimate CSI computation duration of compressing AI-based CSI-RS feedback information at the terminal side or the base station side. Specific methods for defining CSI computation duration include a definition method based on a terminal processing time and a definition method based on model complexity.

When the CSI computation duration is estimated by using the method based on a terminal processing time, the terminal side has the hardware processing capability information of the terminal, such as the floating-point operations that can be performed per second. By processing the complexity of the AI model and the terminal processing capability per unit time (for example, per second), the CSI computation duration under the AI model can be obtained.

When the CSI computation duration is estimated using the method based on model complexity, the terminal side may have the CSI computation duration for processing the baseline AI model or store the processing duration for a preset AI model with various complexity. If the terminal side stores the CSI computation duration for processing the baseline AI model, the CSI computation duration under the selected AI model can be obtained according to a relation between the complexity of the AI model selected by the base station and the complexity of the baseline AI model. If the terminal side stores processing duration for a preset AI model with various complexity, the complexity of the AI model selected by the base station matches the complexity of the preset model, and the CSI computation duration under the selected AI model can be obtained.

When estimating the CSI computation duration at the terminal side, the base station first transmits complexity information of one or a group of available AI models and maximum computation duration requirement to the terminal, and the terminal estimates the CSI computation duration under the corresponding model by using the complexity information of the AI model issued by the base station in combination with the hardware computation power of the terminal through the method based on the terminal processing time or the model complexity.

The terminal compares the estimated CSI computation duration with a maximum computation duration requirement. If the requirement is satisfied, it indicates that the computation power of the terminal can support to use the AI model for compressing the CSI-RS feedback information. The terminal reports the used model and the estimated CSI computation duration to the base station, and the base station configures the CSI-RS according to the reporting situation of the terminal. If the maximum computation duration requirement is not satisfied, it indicates that the terminal computation power does not support the AI model in compressing the CSI-RS feedback information. The terminal does not report information related to AI, and CSI feedback is performed by using a conventional algorithm.

When the CSI computation duration is estimated at the base station side, the terminal first reports the computation capability of the terminal to the base station, and the base station estimates the CSI computation duration under the corresponding model according to the computation power of the terminal in combination with the complexity information of the available AI model through the method based on the terminal processing time or the model complexity. The base station then compares the estimated CSI computation duration with the maximum computation duration requirement. If the requirement is satisfied, the AI model is used to compress the CSI-RS feedback information, the base station configures the CSI-RS according to the estimated CSI computation duration, and transmits a selected AI model parameter to the terminal. If the requirement is not satisfied, CSI feedback is performed using a conventional method. It should be noted that the foregoing example is described by taking the base station as an example. Certainly, those skilled in the art will understand that the network side device in all the examples of the disclosure may be a base station or any other device, which is not repeated here.

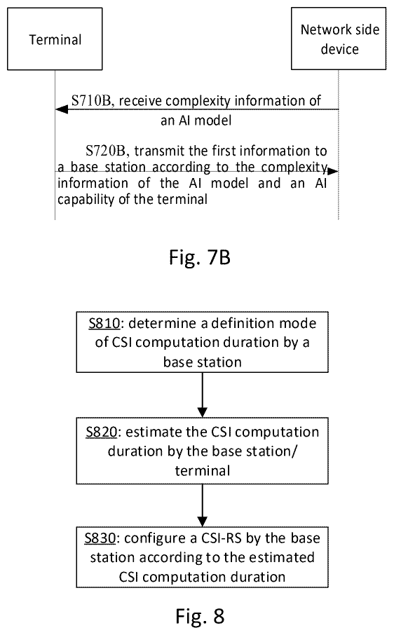

With reference to FIG. 8, the example of the disclosure provides a method for determining the CSI computation duration of compressing AI-based CSI-RS feedback information. The method may include S810-S830.

S810: A definition mode for CSI computation duration is determined by the network side device (in the below shown as the base station). The definition mode is set as a definition mode based on the terminal processing time or the complexity of the AI model compressing the CSI-RS feedback information. For example, the CSI computation duration of the terminal is determined by the base station or the terminal according to the protocol agreement or the self-computation load.

S820: The CSI computation duration is estimated at the base station side or the terminal side according to the set definition mode of the CSI computation duration. Specifically, the CSI computation duration may be defined on the terminal side based on the terminal processing time, defined on the base station side based on the terminal processing time, defined on the terminal side based on the model complexity, and defined on the base station side based on the model complexity.

S830: The base station side configures the CSI-RS according to the estimated CSI computation duration.

It should be noted that the foregoing example is described by taking the base station as an example. Certainly, those skilled in the art will understand that the network side device in all the examples of the disclosure may be a base station or any other device, which is not repeated here. It should be noted that the method can be implemented in combination with other examples of the disclosure, or can be implemented independently, and is not repeated here.

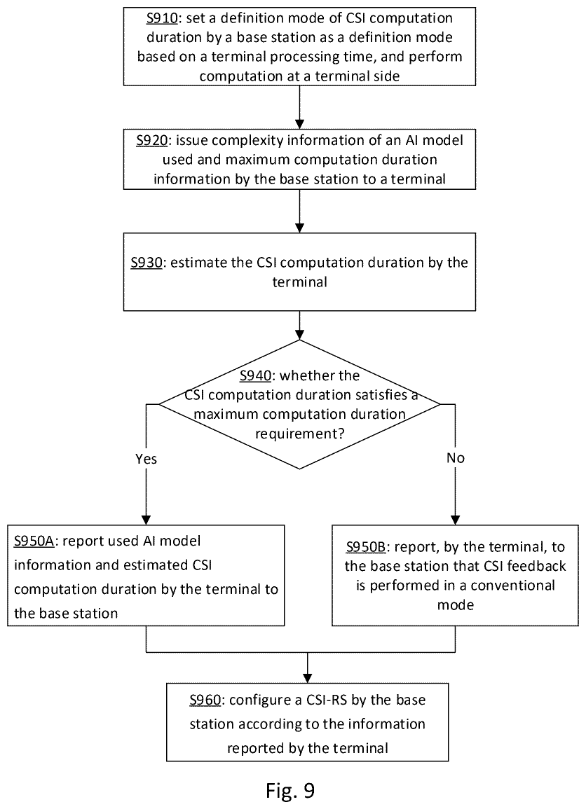

With reference to FIG. 9, a flowchart of defining CSI computation duration at a terminal side based on a terminal processing time in a method for defining the CSI computation duration of compressing AI-based CSI-RS feedback information provided in an example of the disclosure may include S910-S960.

S910: The definition mode of the CSI computation duration is set by a network side device (for example, base station) as a definition mode based on the terminal processing time, and it is determined to estimate the CSI computation duration at the terminal side.

S920: Complexity information of the AI model required for compressing the CSI-RS feedback information is issued by the network side device to the terminal. Moreover, a maximum computation duration requirement is issued to the terminal. In an example, complexity information of the AI model may be defined by using floating-point operations per second (FLOPs) of the AI model. The floating-point operations per second denote the total number of additions or multiplications required for computing using the AI model. The maximum computation duration requirement puts forward a requirement for CSI computation duration. The CSI computation duration using the AI model must be within the maximum computation duration.

S930: The CSI computation duration is estimated by the terminal side according to the hardware computation capability of the terminal and the complexity information of the AI model issued by the base station.

In an example, the hardware computation capability of the terminal may be defined in FLOPS, the floating-point operations per unit time (for example, per second). The floating-point operations per second denote the total number of additions or multiplications that hardware can perform per second.

In an example, the CSI computation duration may be defined by a ratio of complexity of the AI model to the hardware computation power of the terminal. For example, CSI computation duration=FLOPs/FLOPS. The total number of additions or multiplications required by the model is divided by the number of additions or multiplications that the hardware can perform per second to obtain the computation duration required under the AI model.

In an example, the base station side only issues complexity information of a single AI model I, and the terminal can obtain CSI computation duration T corresponding to the model I.

In an example, the base station side issues complexity information of a group of AI models Ii (i=1, 2, 3, . . . ), and the terminal can obtain CSI computation duration Ti (i=1, 2, 3, . . . ) corresponding to the group of models respectively.

S940: The terminal side determines whether the estimated CSI computation duration satisfies the maximum computation duration requirement. If the maximum computation duration requirement is satisfied (Yes in S940), the terminal can use the AI model to compress the CSI-RS feedback information, and report the model information of the AI model used and the estimated CSI computation duration to the base station (S950A). If the maximum computation duration requirement is not satisfied (No in S940), report that the terminal uses a conventional mode to perform CSI-RS feedback information (S950B).

In an example, in all models issued by the base station, if no model satisfies the maximum computation duration requirement, the terminal reports the CSI-RS feedback information by using a conventional algorithm, and does not report the estimated CSI computation duration, reports that there is no AI model, or reports the CSI-RS feedback information not processed by using the AI model.

In an example, in all AI models issued by the base station, if only one AI model satisfies the maximum computation duration requirement, the terminal reports model information of the AI model and corresponding CSI computation duration to the base station.

In an example, in all models issued by the base station, if a plurality of models satisfy the maximum computation duration requirement, the terminal selects an optimal model according to its own characteristics and hardware resource allocation conditions, and reports information of the optimal model and corresponding CSI computation duration to the base station. Alternatively, the terminal reports two or more models with better performance. Alternatively, the terminal reports a list of all available models and priorities.

S960: The CSI-RS is configured by the base station according to the information reported by the terminal.

In an example, when CSI feedback in a conventional mode is reported by the terminal to the base station, the CSI computation duration is obtained by the base station side according to a conventional algorithm, and the CSI-RS is configured.

In an example, after the used AI model information and the estimated CSI computation duration are reported to the base station by the terminal and the CSI-RS feedback information compressed by the AI model is received by the base station side, a corresponding decompression model may be used to obtain the recovered CSI-RS feedback information. When the CSI-RS is configured, the CSI-RS may be configured according to the estimated CSI computation duration.

It should be noted that the foregoing example is described by taking the base station as an example. Certainly, those skilled in the art will understand that the network side device in all the examples of the disclosure may be a base station or any other device, which is not repeated here. It should be noted that the method can be implemented in combination with other examples of the disclosure, or can be implemented independently, and is not repeated here.

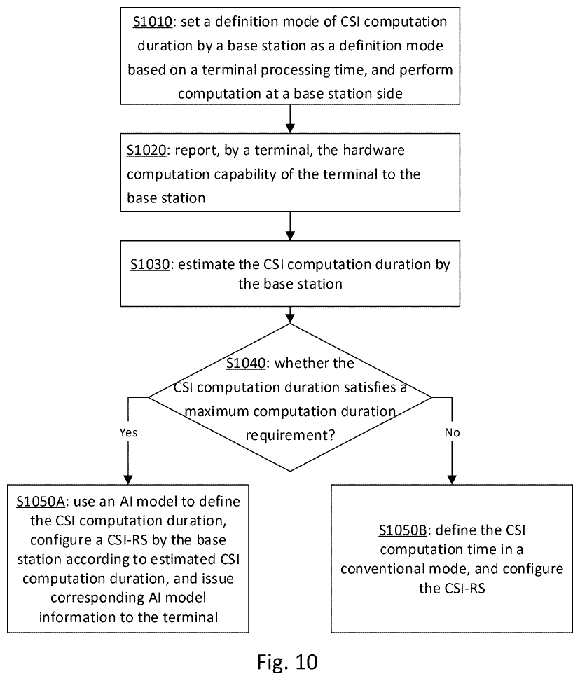

With reference to FIG. 10, a flowchart of defining CSI computation duration at a base station side based on a terminal processing time in a method for defining the CSI computation duration of compressing AI-based CSI-RS feedback information is provided in an example of the disclosure. A specific process is as follows includes S1010-S1040, and one of S1050A or S1050B.

S1010: The definition mode of the CSI computation duration is set according to a preset condition by a base station side as a definition mode based on the terminal processing time, and it is determined to estimate the CSI computation duration at the base station side.

S1020: The hardware computation capability of the terminal is reported by the terminal to the base station.

In an example, the hardware computation capability of the terminal may be defined in FLOPS, the floating-point operations per second. The floating-point operations per second denote the total number of additions or multiplications that hardware can perform per second.

S1030: The CSI computation duration is estimated by the base station according to the hardware computation capability of the terminal and the complexity information of the AI model used.

In an example, complexity information of the AI model may be defined using FLOPs of the AI model. The floating-point operations per second denote the total number of additions or multiplications required for computing using the AI model. The CSI computation duration may be defined by a ratio of complexity of the AI model to the hardware computation power of the terminal. For example, CSI computation duration=FLOPs/FLOPS. The total number of additions or multiplications required by the model is divided by the number of additions or multiplications that the hardware can perform per second to obtain the computation duration required under the AI model.

In an example, if only one model I is available, corresponding CSI computation duration T may be obtained by the base station according to complexity information of the model I.

In an example, if one group of models Ii (i=1, 2, 3, . . . ) are available, CSI computation duration Ti (i=1, 2, 3, . . . ) corresponding to the group of models may be obtained by the base station according to complexity information of the group of available respectively.

S1040: The base station determines whether the estimated CSI computation duration satisfies the maximum computation duration requirement. If the maximum computation duration requirement is satisfied (Yes in S1040), the AI model may be used by the terminal to compress the CSI-RS feedback information, and the compressed CSI-RS feedback information is decompressed by using a corresponding decompression model after received by the base station (S1050A). If the maximum computation duration requirement is not satisfied (No in S1040), define the CSI computation time in a conventional mode and use to perform CSI-RS feedback (S1050B).

In an example, in all available models, if no AI model satisfies the maximum computation duration requirement, the CSI-RS feedback information is reported by the terminal side by using a conventional algorithm. The CS feedback information is reported by using the conventional algorithm here at least as follows: part of the CSI-RS feedback information is reported.

In an example, in all available models, if only one model satisfies the maximum computation duration requirement, the CSI-RS is configured by the base station according to the estimated CSI computation duration, and corresponding AI model information is issued to the terminal.

In an example, in all available AI models, if a plurality of AI models satisfy the maximum computation duration requirement, an optimal model is selected by the base station according to characteristics of the base station and computation resource allocation conditions, a CSI-RS is configured according to CSI computation duration of the optimal model, and information of the optimal model is issued to the terminal.

It should be noted that the foregoing example is described by taking the base station as an example. Certainly, those skilled in the art will understand that the network side device in all the examples of the disclosure may be a base station or any other device, which is not repeated here. It should be noted that the method can be implemented in combination with other examples of the disclosure, or can be implemented independently, and is not repeated here.

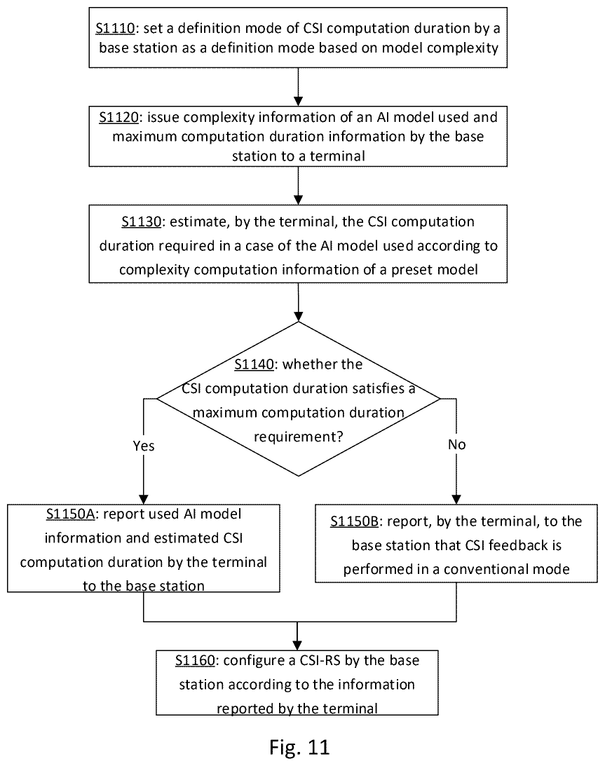

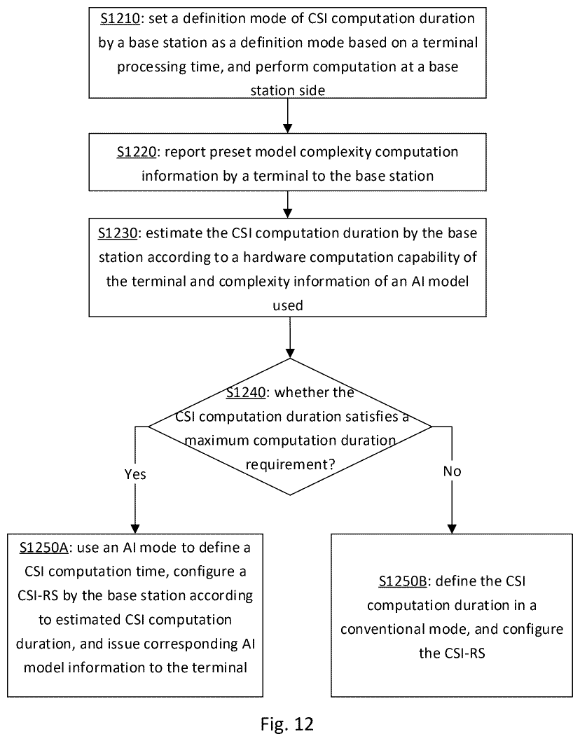

With reference to FIG. 11, a flowchart of defining CSI computation duration at a terminal side based on model complexity in a method for defining the CSI computation duration of compressing AI-based CSI-RS feedback information is provided in an example of the disclosure. A specific process is as follows and includes S1110-S1160.

S1110: The definition mode of the CSI computation duration is set by a base station side according to preset conditions as a definition mode based on the model complexity, and it is determined to estimate the CSI computation duration at the terminal side.

S1120: Complexity information of the AI model required for compressing the CSI-RS feedback information is issued by the base station side to the terminal. Moreover, a maximum computation duration requirement is issued to the terminal.

S1130: The CSI computation duration required under the AI model is estimated by the terminal side according to complexity computation information of the preset model.

In an example, the terminal side is preset with computation duration information for models with different complexity. The terminal matches the complexity information of the AI model issued by the base station and preset information to obtain the corresponding CSI computation duration.

In an example, the terminal side is preset with baseline CSI computation duration information corresponding to a certain baseline model. The CSI computation duration of the AI model used can be obtained by scaling the CSI computation duration of baseline AI model by the terminal according to a relation between the complexity information of the AI model issued by the base station and the complexity of the baseline AI model.

In an example, the base station side only issues complexity information of a single AI model I, and the terminal can obtain CSI computation duration T corresponding to the model I.

In an example, the base station side issues complexity information of a group of AI models Ii (i=1, 2, 3, . . . ), and the terminal can obtain CSI computation duration Ti (i=1, 2, 3, . . . ) corresponding to the group of models respectively.

S1140: The terminal side determines whether the estimated CSI computation duration satisfies the maximum computation duration requirement. If the maximum computation duration requirement is satisfied (Yes in S1140), the terminal can use the AI model to compress the CSI-RS feedback information, and report the AI model information and the estimated CSI computation duration to the base station (S1150A). If the maximum computation duration requirement is not satisfied (No in S1140), report that the terminal uses a conventional mode to perform CSI feedback (S1150B).

In an example, in all models issued by the base station, if no model satisfies the maximum computation duration requirement, the terminal reports the CSI-RS feedback information by using a conventional algorithm, and does not report the estimated CSI computation duration.

In an example, in all models issued by the base station, if only one model satisfies the maximum computation duration requirement, model information, for example, corresponding CSI computation duration is reported by the terminal to the base station.

In an example, in all models issued by the base station, if a plurality of models satisfy the maximum computation duration requirement, the terminal selects an optimal model according to its own characteristics and hardware resource allocation conditions, and reports information of the optimal model and corresponding CSI computation duration to the base station.

S1160: The CSI-RS is configured by the base station according to the information reported by the terminal.

In an example, when CSI feedback in a conventional mode is reported by the terminal to the base station, the CSI computation duration is obtained by the base station side according to a conventional algorithm, and the CSI-RS is configured.

In an example, after the used AI model information and the estimated CSI computation duration are reported to the base station by the terminal and the CSI-RS feedback information compressed by the AI model is received by the base station side, a corresponding decompression model may be used to obtain the recovered CSI-RS feedback information. When the CSI-RS is configured, the CSI-RS may be configured according to the estimated CSI computation duration.

It should be noted that the foregoing example is described by taking the base station as an example. Certainly, those skilled in the art will understand that the network side device in all the examples of the disclosure may be a base station or any other device, which is not repeated here. It should be noted that the method can be implemented in combination with other examples of the disclosure, or can be implemented independently, and is not repeated here.

With reference to FIG. 12, a flowchart of defining CSI computation duration at a base station side based on model complexity in a method for defining the CSI computation duration of compressing AI-based CSI-RS feedback information is provided in an example of the disclosure. A specific process is as follows and includes S1210-S1240, and one of S1250A or S1250B.

S1210: The definition mode of the CSI computation duration is set by the base station side according to preset conditions as a definition mode based on the model complexity, and it is determined to estimate the CSI computation duration at the base station side.

S1220: Preset model complexity computation information is reported by the terminal to the base station.

In an example, the terminal side is preset with computation duration information for models with different complexity.

In an example, the terminal side is preset with baseline CSI computation duration information corresponding to a certain baseline model.

S1230: The CSI computation duration is estimated by the base station according to the complexity computation information of the terminal and the complexity information of the AI model used.

In an example, the terminal side is preset with computation duration information for models with different complexity. The terminal matches the complexity information of the AI model issued by the base station and preset information to obtain the corresponding CSI computation duration.

In an example, the terminal side is provided with baseline CSI computation duration information corresponding to a certain baseline model. The CSI computation duration of the AI model used can be obtained by scaling the CSI computation duration of baseline model by the terminal according to a relation between the complexity information of the AI model issued by the base station and the complexity of the baseline model.

In an example, if only one model I is available, corresponding CSI computation duration T may be obtained by the base station according to complexity information of the model I.

In an example, if one group of models Ii (i=1, 2, 3, . . . ) are available, CSI computation duration Ti (i=1, 2, 3, . . . ) corresponding to the group of models may be obtained by the base station according to complexity information of the group of available respectively.

S1240: The base station determines whether the estimated CSI computation duration satisfies the maximum computation duration requirement. If the maximum computation duration requirement is satisfied (Yes in S1240), the AI model may be used by the terminal to compress the CSI-RS feedback information, and the compressed CSI-RS feedback information is decompressed by using a corresponding decompression model after received by the base station (S1250A). If the maximum computation duration requirement is not satisfied (No in S1240), define the CSI computation duration in a conventional mode and is used to perform CSI-RS feedback (S1250B).

In an example, in all available models, if no AI model satisfies the maximum computation duration requirement, the CSI-RS feedback information is reported by using a conventional algorithm.

In an example, in all available models, if only one model satisfies the maximum computation duration requirement, the CSI-RS is configured by the base station according to the estimated CSI computation duration, and corresponding AI model information is issued to the terminal.

In an example, in all available models, if a plurality of models satisfy the maximum computation duration requirement, an optimal model is selected by the base station according to characteristics of the base station and computation resource allocation conditions, a CSI-RS is configured according to CSI computation duration of the optimal model, and information of the optimal model is issued to the terminal.

It should be noted that the foregoing example is described by taking the base station as an example. Certainly, those skilled in the art will understand that the network side device in all the examples of the disclosure may be a base station or any other device, which is not repeated here. It should be noted that the method can be implemented in combination with other examples of the disclosure, or can be implemented independently, and is not repeated here.

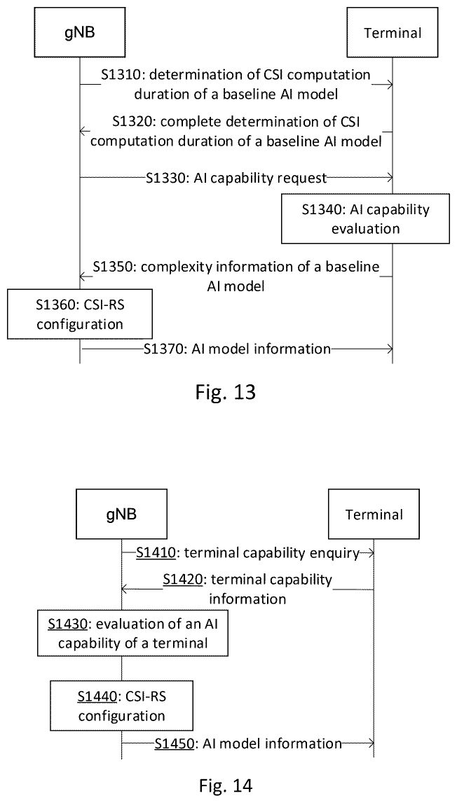

With reference to FIG. 13, a signaling interaction diagram of computing CSI computation duration at a terminal side in a method for defining the CSI computation duration of compressing AI-based CSI-RS feedback information provided in an example of the disclosure is as follows and includes S1310-S1370.

S1310: An AI baseline model determination (AI-based CSI delay computation) message is transmitted from the base station (here shown as a gNB) to the terminal, and the terminal is required to evaluate the CSI computation duration.

S1320: Completion of CSI computation duration determination of the baseline AI model (AI-based CSI delay computation ready) is transmitted from the terminal to the base station to determine that evaluation of the CSI computation duration is started.

S1330: An AI capability request is transmitted from the base station to the terminal. The AI capability request includes information such as model complexity and maximum computation duration stored in the base station.

S1340: The CSI computation duration is obtained by the terminal through a method based on a terminal processing time or model complexity, and whether to use the AI mode is determined according to the maximum computation duration.

S1350: The complexity information of the baseline AI model (AI-based CSI delay computation information) is transmitted from the terminal to the base station. Whether the AI model is used for compressing the CSI-RS feedback information, the used AI model information and the corresponding CSI computation duration are reported.

S1360: The CSI-RS is configured by the base station according to the complexity information of the baseline AI model (AI-based CSI delay computation information).

If the AI mode is used, an AI model parameter used is issued by the base station to the terminal (S1370).

With reference to FIG. 14, a signaling interaction diagram of computing CSI computation duration at a base station side, here shown as a gNB, in a method for defining the CSI computation duration of compressing AI-based CSI-RS feedback information provided in an example of the disclosure is as follows and includes S1410-S1450.

S1410: the base station transmits a terminal capability inquiry to a terminal, and requires the terminal to report a computation capability of the terminal.

S1420: The terminal transmits capability information of the terminal to the base station and reports computation capability information of the terminal. The capability information may at least indicate an AI capability of the terminal.

S1430: The base station evaluates the AI capability of the terminal by using a method based on a terminal processing time or model complexity according to stored complexity information of an AI model, and determines whether to use an AI mode.

S1440: The base station configures a CSI-RS according to an evaluation result.

If the AI mode is used, the base station transmits model information of the AI model to the terminal (S1450).

A CSI computation time of AI-based CSI compression is computed at a terminal side or the base station side. When the terminal side performs computation, the base station issues the complexity information of the AI model. The terminal estimates the CSI computation time in combination with a self-computation power condition. When the base station side performs computation, the terminal reports the self-computation power information, and the base station estimates the CSI computation time in combination with the stored complexity information of an AI model.

In some examples, the CSI computation time defined based on the terminal processing time is proposed. The base station side stores the complexity information of the AI model. The terminal side stores the computation power information of the terminal. The CSI computation time can be obtained by processing the model complexity and the computation power of the terminal.

In some other examples, the CSI computation time defined based on the model complexity is proposed. When the terminal side stores the CSI computation duration for processing the baseline AI model, the CSI computation duration under the selected AI model can be obtained according to a relation between the complexity of the AI model selected by the base station and the complexity of the baseline AI model. When the terminal side stores processing duration for a preset AI model with various complexity, the complexity of the AI model selected by the base station matches the complexity of the preset model, and the CSI computation duration under the selected AI model can be obtained.

It should be noted that the foregoing example is described by taking the base station as an example. Certainly, those skilled in the art will understand that the network side device in all the examples of the disclosure may be a base station or any other device, which is not repeated here. It should be noted that the method can be implemented in combination with other examples of the disclosure, or can be implemented independently, and is not repeated here.

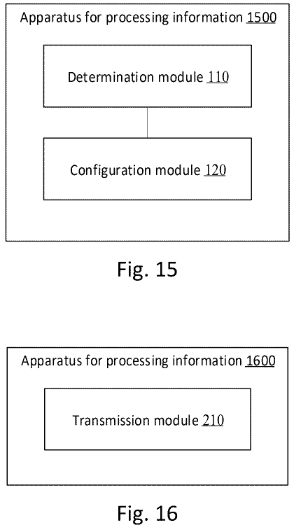

As shown in FIG. 15, an apparatus for processing information is provided in an example of the disclosure. The apparatus 1500 includes a determination module 110 and a configuration module 120.

The determination module 110 used to determine whether a terminal supports compression of channel state information-reference signal (CSI-RS) feedback information with at least one artificial intelligence (AI) model.

The configuration module 120 used to configure a CSI-RS according to whether the terminal supports compression of CSI-RS feedback information with at least one AI model.

The apparatus for processing information 1500 may be encompassed in the terminal.

In some examples, the determination module 110 and the configuration module 120 may be program modules. After being executed by one or more processors, the program modules can achieve the functions.

In some other examples, the determination module 110 and the configuration module 120 may be hardware-software combined modules. The hardware-software combined modules include, but are not limited to, programmable arrays. The programmable arrays include, but are not limited to, field programmable arrays and/or complex programmable arrays.

In still some examples, the determination module 110 and the configuration module 120 may be pure hardware modules. The pure hardware modules include, but are not limited to, application-specific integrated circuits or one or more processors.

In some examples, the determination module 110 is configured to transmit complexity information of the AI model to the terminal; receive first information provided by the terminal according to the complexity information; and determine whether the terminal supports compression of the CSI-RS feedback information with the at least one AI model according to the first information.

In some examples, the first information indicating that the terminal supports compression of the CSI-RS feedback information with the at least one AI model includes: a model identifier indicating the AI model supported by the terminal for compressing the CSI-RS feedback information; and CSI computation duration indicating duration required by using the AI model with the model identifier to compress the CSI-RS feedback information by the terminal.

In some examples, the first information indicating that the terminal does not support compression of CSI-RS feedback information with at least one AI model indicates that a partial reporting mode is used for the CSI-RS feedback information.

In some examples, the complexity information indicates at least one of: total floating-point operations per second of a corresponding AI model, where the total floating-point operations per second and a maximum allowable value of CSI computation duration are jointly used for the terminal to determine whether to support the corresponding AI model in compressing the CSI-RS feedback information; and a first ratio of complexity of the corresponding AI model to complexity of a baseline AI model, where the first ratio is used for the terminal to determine whether to support the corresponding AI model in compressing the CSI-RS feedback information in combination with the AI capability of the terminal and the complexity of the baseline AI model.

In some examples, the determination module 110 is configured to receive AI capability information transmitted from the terminal; and determine whether the terminal supports compression of the CSI-RS feedback information with the at least one AI model according to the AI capability information.

In some examples, the AI capability information indicates at least one of: whether the terminal has the AI capability; floating-point operations per second supported by the terminal; floating-point operations per second supported by the terminal within a maximum allowable value of CSI computation duration; and/or a second ratio indicating a ratio of the AI capability of the terminal to complexity of a baseline AI model.

In some examples, the configuration module 120 is configured to configure a type of the CSI-RS feedback information reported by the terminal according to whether the terminal supports compression of CSI-RS feedback information with at least one AI model; and determine, when the terminal supports compression of CSI-RS feedback information with at least one AI model, CSI computation duration when a supported AI model is used to compress the CSI-RS feedback information, and configure a period of the CSI-RS.

As shown in FIG. 16, an apparatus for processing information is provided in an example of the disclosure. The apparatus 1600 includes a transmission module 210.

The transmission module 210 configured to transmit second information, where the second information is used for a base station to determine whether the terminal supports compression of CSI-RS feedback information with at least one AI model.

The apparatus for processing information 1600 may be encompassed in the terminal.

In some examples, the transmission module 210 may be a program module. The program module can allow the base station to determine whether the terminal supports the AI model in compressing the CSI-RS feedback information after being executed by one or more processors.

In some other examples, the transmission module 210 may be a hardware-software combined module. The hardware-software combined module includes, but is not limited to, a programmable array. The programmable array includes, but is not limited to, a field programmable array and/or a complex programmable array, and/or one or more processors.

In still some examples, the transmission module 210 may be a pure hardware module. The pure hardware module includes, but is not limited to, an application-specific integrated circuit and/or one or more processors.

In some examples, the second information includes AI capability information indicating an AI capability of the terminal.

In some examples, the AI capability information indicates at least one of: whether the terminal has the AI capability; floating-point operations per second supported by the terminal; floating-point operations per second supported by the terminal within a maximum allowable value of CSI computation duration; and/or a second ratio indicating a ratio of the AI capability of the terminal to complexity of a baseline AI model.

In some examples, the second information includes first information used to indicate whether the terminal supports compression of the CSI-RS feedback information with the at least one AI model.

In some examples, the first information indicating that the terminal supports compression of the CSI-RS feedback information with the at least one AI model includes: a model identifier indicating the AI model supported by the terminal for compressing the CSI-RS feedback information; and CSI computation duration indicating duration required by using the AI model with the model identifier to compress the CSI-RS feedback information by the terminal.

In some examples, the first information indicating no support of the terminal indicates that a partial reporting mode is used for the CSI-RS feedback information.

In some examples, the apparatus 1600 further includes a reception module configured to receive complexity information of the AI model.

The transmission module 210 is configured to transmit the first information to the base station according to the complexity information of the AI model and an AI capability of the terminal.

In some examples, the transmission module 210 is further configured to execute one of the following: the first information indicating that the at least one AI model is supported in compressing the CSI-RS feedback information is transmitted to the base station when it is determined that the terminal supports one AI model in compressing the CSI-RS feedback information according to the complexity information of the AI model and the AI capability of the terminal; the one AI model supported by the terminal is selected according to a resource scheduling situation of the terminal to indicate to the base station the first information of supporting the one AI model in compressing the CSI-RS feedback information when it is determined that the terminal supports a plurality of AI models in compressing the CSI-RS feedback information according to the complexity information of the AI model and the AI capability of the terminal; and the first information indicating that the terminal does not support the at least one AI model in compressing the CSI-RS feedback information is transmitted to the base station when it is determined that the terminal does not support the AI model in compressing the CSI-RS feedback information according to the complexity information of the AI model and the AI capability of the terminal.

In some examples, the complexity information indicates at least one of: total floating-point operations per second of a corresponding AI model, where the total floating-point operations per second and a maximum allowable value of CSI computation duration are jointly used for the terminal to determine whether to support the corresponding AI model in compressing the CSI-RS feedback information; and a first ratio of complexity of the corresponding AI model to complexity of a baseline AI model, where the first ratio is used for the terminal to determine whether to support the corresponding AI model in compressing the CSI-RS feedback information in combination with the AI capability of the terminal and the complexity of the baseline AI model.

A communication device is provided in an example of the disclosure. The communication device includes a memory and one or more processors.

The memory configured to store one or more processor-executable instructions.

The one or more processors connected to the memory separately; where the one or more processors are configured to execute the method for processing information according to any of the foregoing technical solutions.

The one or more processors may include various types of storage media. The storage media are non-transitory computer storage media that can continue remembering information stored after the communication device is powered off.

Here, the communication device includes a terminal or a network element. The network element may be any one of a first network element to a fourth network element. The network element can be the network side device of the included examples.

The one or more processors may be connected to the memory through a bus, etc. and configured to read an executable program stored in the memory, for example, at least one of the methods shown in FIGS. 2-14.

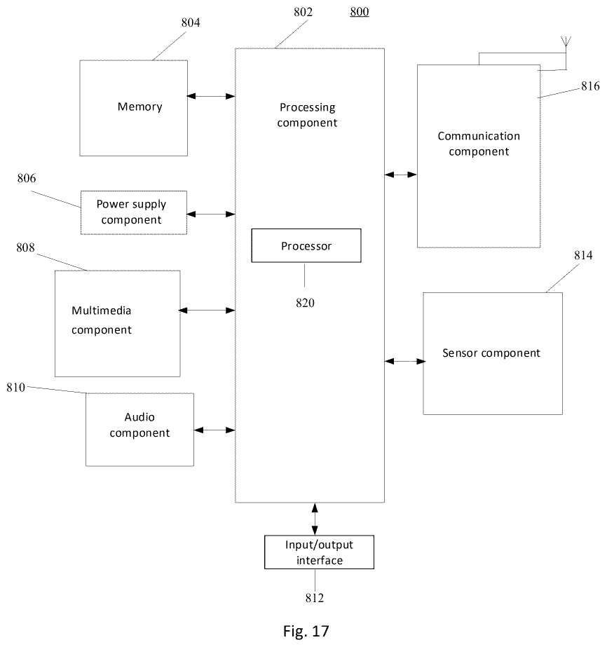

FIG. 17 is a block diagram of a terminal 800 according to an example. For example, the terminal 800 may be a mobile phone, a computer, digital broadcast user equipment, a message transceiving device, a gaming console, a tablet device, a medical device, a fitness device, a personal digital assistant, etc.

With reference to FIG. 17, the terminal 800 may include one or more of a processing component 802, a memory 804, a power supply component 806, a multimedia component 808, an audio component 810, an input/output (I/O) interface 812, a sensor component 814, and a communication component 816.

The processing component 802 generally controls overall operation of the terminal 800, for example, operations associated with display, phone calls, data communications, camera operations, and recording operations. The processing component 802 may include one or more processors 820 to execute an instruction, so as to complete all or some steps of the methods. Moreover, the processing component 802 may include one or more modules that facilitate interaction between the processing component 802 and other assemblies. For example, the processing component 802 may include a multimedia module, so as to facilitate the interaction between the multimedia component 808 and the processing component 802.

The memory 804 is configured to store various types of data to support an operation on the terminal 800. Instances of such data include an instruction, operated on the terminal 800, for any application or method, contact data, phonebook data, messages, pictures, video, etc. The memory 804 may be implemented through any type of volatile or non-volatile storage devices or their combinations, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, and an optical disk.

The power supply component 806 supplies power to the various assemblies of the terminal 800. The power supply component 806 may include a power management system, one or more power supplies, and other assemblies associated with power generation, management, and distribution for the terminal 800.

The multimedia component 808 includes a screen that provides an output interface between the terminal 800 and the user. In some examples, the screen may include a liquid crystal display (LCD) and a touch panel (TP). If including the touch panel, the screen may be implemented as a touch screen, so as to receive an input signal from the user. The touch panel includes one or more touch sensors, so as to sense touches, swipes, and gestures on the touch panel. The touch sensor may sense a boundary of a touch or swipe action and measure time and pressure associated with a touch or swipe operation. In some examples, the multimedia component 808 includes a front-facing camera and/or a rear-facing camera. When the terminal 800 is in an operational mode, for example, a photographing mode or a video mode, the front-facing camera and/or the rear-facing camera may receive external multimedia data. Each of the front-facing camera and the rear-facing camera may be a fixed optical lens system or have a focal length and an optical zoom capability.

The audio component 810 is configured to output and/or input audio signals. For example, the audio component 810 includes a microphone (MIC) configured to receive an external audio signal when the terminal 800 is in operational modes, such as a call mode, a recording mode, and a speech recognition mode. The audio signals received may be further stored in the memory 804 or transmitted via the communication component 816. In some examples, the audio component 810 further includes a speaker configured to output an audio signal.

The I/O interface 812 provides an interface between the processing component 802 and a peripheral interface module. The peripheral interface module may be a keyboard, a click wheel, a button, etc. These buttons may include, but are not limited to, a home button, a volume button, a start button, and a lock button.

The sensor component 814 includes one or more sensors for providing state evaluation of various aspects of the terminal 800. For example, the sensor component 814 may detect an on/off state of the device 800 and relative positioning of the components. For example, the components are a display and a keypad of the terminal 800. The sensor component 814 may also detect a change in position of the terminal 800 or a component of the terminal 800, the presence or absence of contact between the user and the terminal 800, orientation or acceleration/deceleration of the terminal 800, and temperature variation of the terminal 800. The sensor component 814 may include a proximity sensor configured to detect presence of nearby objects in absence of any physical contact. The sensor component 814 may further include a light sensor, such as a complementary metal-oxide-semiconductor transistor (CMOS) or charge coupled device (CCD) image sensor configured to be used in imaging application. In some examples, the sensor component 814 may further include an acceleration sensor, a gyroscope sensor, a magnetic sensor, a pressure sensor, or a temperature sensor.

The communication component 816 is configured to facilitate communication between the terminal 800 and other devices in a wired or radio mode. The terminal 800 may access a wireless network based on a communication standard, for example, Wi-Fi, 2G, or 3G, or their combinations. In an example, the communication component 816 receives a broadcast signal or broadcast related information from an external broadcast management system via a broadcast channel. In an example, the communication component 816 further includes a near field communication (NFC) module, so as to facilitate short-range communication. For example, the NFC module may be implemented on the basis of a radio frequency identification (RFID) technology, an infrared data association (IrDA) technology, an ultra wide band (UWB) technology, a Bluetooth (BT) technology, etc.

In an example, the terminal 800 may be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic elements for executing any of the methods.

In an example, a non-transitory computer-readable storage medium is further provided and includes instructions, for example, a memory 804 including instructions. The instructions are executable by one or more processors 820 of a terminal 800, to complete any of the methods. For example, the non-transitory computer-readable storage medium may be an ROM, a random access memory (RAM), a compact disk read-only memory (CD-ROM), a magnetic tape, a floppy disk, an optical data storage device, etc.

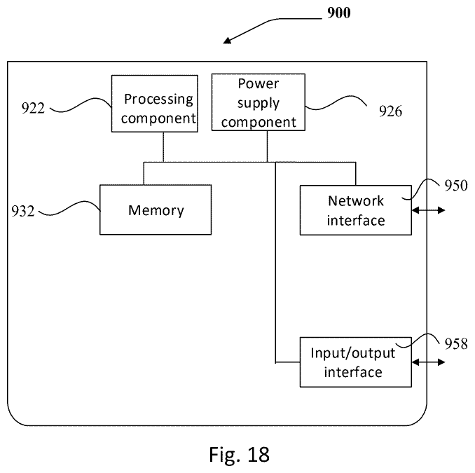

As shown in FIG. 18, a structure of a communication device is shown according to an example of the disclosure. For example, a communication device 900 may be provided as a network side device. The communication device 900 may be the foregoing network side device or base station.

With reference to FIG. 18, the communication device 900 may be the foregoing base station. The communication device 900 may include a processing component 922, and further includes one or more processors (not shown) and memory resources represented by a memory 932 and configured to store an instruction executable by the processing component 922, for example, an application (not shown). The application stored in the memory 932 may include one or more modules, each of which corresponds to a set of instructions. Moreover, the processing component 922 is configured to execute an instruction, so as to execute any one of the methods applied to the access device, for example, the methods shown in any one of FIGS. 4-9.

The communication device 900 may further include a power supply component 926 configured to execute power supply management of the communication device 900, a wired or radio network interface 950 configured to connect the communication device 900 to a network, and an input/output (I/O) interface 958. The communication device 900 may operate based on an operating system stored in the memory 932, such as Windows ServerTM, Mac OS XTM, UnixTM, LinuxTM, and FreeBSDTM.

Those skilled in the art will readily conceive of other embodiments of the disclosure after consideration of the description and practice of the invention disclosed here. The disclosure is intended to cover any variations, uses, or adaptive changes of the disclosure that follow the general principles of the disclosure and include common general knowledge or customary technical means in the art not disclosed in the disclosure. The description and the examples are merely deemed as illustrative, and the true scope and spirit of the disclosure are indicated by the following claims.

It should be understood that the disclosure is not limited to the precise structures that have been described herein and shown in the accompanying drawings, and that various modifications and changes can be made without departing from the scope of the disclosure. The scope of the disclosure is merely limited by the appended claims.

1. A method for processing information, performed by a base station, comprising:
determining whether a terminal supports compression of channel state information-reference signal (CSI-RS) feedback information with at least one artificial intelligence (AI) model; and
configuring a CSI-RS according to whether the terminal supports the compression of the CSI-RS feedback information with the at least one AI model.

2. The method according to claim 1, wherein determining whether the terminal supports the compression of the CSI-RS feedback information with the at least one AI model comprises:
transmitting complexity information of the at least one AI model to the terminal;
receiving first information provided by the terminal according to the complexity information; and
determining whether the terminal supports the compression of the CSI-RS feedback information with the at least one AI model according to the first information.

3. The method according to claim 2, wherein the first information indicating that the terminal supports the compression of the CSI-RS feedback information with the at least one AI model comprises:
a model identifier indicating one or more AI models supported by the terminal for compressing the CSI-RS feedback information; and
CSI computation duration indicating duration required by using the one or more AI models with the model identifier to compress the CSI-RS feedback information by the terminal.

4. The method according to claim 2, wherein the first information indicating that the terminal does not support the compression of the CSI-RS information feedback with the at least one AI model indicates that a partial reporting mode is used for the CSI-RS feedback information.

5. The method according to claim 2, wherein the complexity information indicates at least one of:
total floating-point operations per second of a corresponding AI model, wherein the total floating-point operations per second and a maximum allowable value of CSI computation duration are jointly used for the terminal to determine whether to support the corresponding AI model in compressing the CSI-RS feedback information; and
a first ratio of complexity of the corresponding AI model to the complexity of a baseline AI model, wherein the first ratio is used for the terminal to determine whether to support the corresponding AI model in compressing the CSI-RS feedback information in combination with the AI capability of the terminal and the complexity of the baseline AI model.

6. The method according to claim 1, wherein determining whether the terminal supports the compression of CSI-RS feedback information with at least one AI model comprises:
receiving AI capability information transmitted from the terminal; and
determining whether the terminal supports the compression of the CSI-RS feedback information with the at least one AI model according to the AI capability information.

7. The method according to claim 6, wherein the AI capability information indicates at least one of:
whether the terminal has the AI capability;
floating-point operations per second supported by the terminal;
floating-point operations per second supported by the terminal within a maximum allowable value of CSI computation duration; and
a second ratio indicating a ratio of the AI capability of the terminal to complexity of a baseline AI model.

8. The method according to 1, wherein configuring the CSI-RS according to whether the terminal supports compression of the CSI-RS feedback information with the at least one AI model comprises:
configuring a type of the CSI-RS feedback information reported by the terminal according to whether the terminal supports the compression of the CSI-RS feedback information with the at least one AI model; and
determining, when the terminal supports the compression of the CSI-RS feedback information with the at least one AI model, CSI computation duration when a supported AI model is used to compress the CSI-RS feedback information, and configuring a period of the CSI-RS.

9. A method for processing information, performed by a terminal, comprising:
transmitting second information, wherein the second information is used for a base station to determine whether the terminal supports compression of channel state information-reference signal (CSI-RS) feedback information with at least one artificial intelligence (AI) model.

10. The method according to claim 9, wherein the second information comprises:
AI capability information indicating an AI capability of the terminal.

11. The method according to claim 10, wherein the AI capability information indicates at least one of:
whether the terminal has the AI capability;
floating-point operations per second supported by the terminal;
floating-point operations per second supported by the terminal within a maximum allowable value of CSI computation duration; and
a second ratio indicating a ratio of the AI capability of the terminal to complexity of a baseline AI model.

12. The method according to claim 9, wherein the second information comprises:
first information used to indicate whether the terminal supports the compression of the CSI-RS feedback information with the at least one AI model.

13. The method according to claim 12, wherein the first information indicating that the terminal supports the compression of the CSI-RS feedback information with the at least one AI model comprises:
a model identifier indicating one or more AI models supported by the terminal for compressing the CSI-RS feedback information; and
CSI computation duration indicating duration required by using the one or more AI models with the model identifier to compress the CSI-RS feedback information by the terminal.

14. The method according to claim 12, wherein the first information indicating that the terminal does not support the compression of the CSI-RS information feedback with the at least one AI model indicates that a partial reporting mode is used for the CSI-RS feedback information.

15. The method according to claim 12, further comprising:
receiving complexity information of the at least one AI model; and
the transmitting second information comprises:
transmitting the first information to the base station according to the complexity information of the at least one AI model and an AI capability of the terminal.

16. The method according to claim 15, wherein transmitting the first information to the base station according to the complexity information of the at least one AI model and the AI capability of the terminal comprises at least one of:
transmitting the first information indicating that the at least one AI model is supported in compressing the CSI-RS feedback information to the base station when it is determined that the terminal supports one AI model in compressing the CSI-RS feedback information according to the complexity information of the at least one AI model and the AI capability of the terminal;
selecting, according to a resource scheduling situation of the terminal, the one AI model supported by the terminal, and sending to the base station the first information of supporting the one AI model in compressing the CSI-RS feedback information when it is determined that the terminal supports a plurality of AI models in compressing the CSI-RS feedback information according to the complexity information of the at least one AI model and the AI capability of the terminal; and
transmitting the first information indicating that the terminal does not support the at least one AI model in compressing the CSI-RS feedback information to the base station when it is determined that the terminal does not support the at least one AI model in compressing the CSI-RS feedback information according to the complexity information of the at least one AI model and the AI capability of the terminal.

17. The method according to claim 15, wherein the complexity information indicates at least one of:
total floating-point operations per second of a corresponding AI model, wherein the total floating-point operations per second and a maximum allowable value of CSI computation duration are jointly used for the terminal to determine whether to support the corresponding AI model in compressing the CSI-RS feedback information; and
a first ratio of complexity of the corresponding AI model to the complexity of a baseline AI model, wherein the first ratio is used for the terminal to determine whether to support the corresponding AI model in compressing the CSI-RS feedback information in combination with the AI capability of the terminal and the complexity of the baseline AI model.

18-19. (canceled)

20. A communication device, comprising: one or more processors, a transceiver, a memory, and an executable program stored in the memory and executable by the one or more processors, wherein the one or more processors are collectively configured to: transmit second information, wherein the second information is used for a base station to determine whether a terminal supports compression of a channel state information-reference signal (CSI-RS) feedback information with at least one artificial intelligence (AI) model.

21. A non-transitory computer-readable storage medium, storing an executable program, wherein the executable program implements the method according to claim 9 after being executed by one or more processors.

22. The method according to claim 16, wherein the complexity information indicates at least one of:
total floating-point operations per second of a corresponding AI model, wherein the total floating-point operations per second and a maximum allowable value of CSI computation duration are jointly used for the terminal to determine whether to support the corresponding AI model for compressing the CSI-RS feedback information; and
a first ratio of complexity of the corresponding AI model to the complexity of a baseline AI model, wherein the first ratio is used for the terminal to determine whether to support the corresponding AI model for compressing the CSI-RS feedback information in combination with the AI capability of the terminal and the complexity of the baseline AI model.
